(19) United States
(12) Patent Application Publication
(10) Pub. No.: US 2007/0273978 A1
(43) Pub. Date: Nov. 29, 2007

(54) Controllable optical lens

(75) Inventors: Bernardus H.W. Hendriks, Eindhoven (NL); Coen T.H.F. Liedenbaum, Oss (NL); Stein Kuiper, Vught (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,369

(22) PCT Filed: Mar. 29, 2005
(86) PCT No.: PCT/IB05/51054

§ 371 Date: Sep. 27, 2006

(30) Foreign Application Priority Data
Mar. 30, 2004 (GB) 0407239.3

(51) Int. Cl. G02B 26/02

(52) U.S. Cl. 359/665; 359/362; 359/228

(57) ABSTRACT

A controllable optical lens system comprises a chamber housing first and second fluids, the interface between the fluids defining a lens surface. An electrode controls the shape of the lens surface and has first and second electrodes. The current supplied by a power source to the electrode arrangement is monitored, and the charge supplied is derived. The voltage on one of the electrodes of the electrode arrangement is also monitored. A desired lens power is used to derive a control value for controlling the total charge to be supplied to the electrode arrangement. The drive scheme is independent of some of the lens characteristics, and is more easily implemented than a feedback control system using capacitive sensing.

This invention relates to a controllable optical lens, in particular using the so-called electrowetting principle (also known as electrocapillarity).

An electrowetting lens comprises a chamber housing two non-miscible liquids, such as an electrically insulating oil and a water based conducting salt solution, and the meniscus between these fluids defines a refractive index boundary and therefore performs a lens function. The shape of the meniscus is electrically controllable to vary the power of the lens. The fluid may comprise a liquid, vapour, gas, plasma or a mixture thereof.

The electrical control of the lens shape is achieved using an outer annular control electrode, and the electrowetting effect is used to control the contact angle of the meniscus at the outside edge of the chamber, thereby changing the meniscus shape.

The basic design and operation of an electrowetting lens will be well known to those skilled in the art. By way of example, reference is made to WO 03/069380.

Electrowetting lenses are compact and can provide a variable focusing function without any mechanical moving parts. They have been proposed in various applications, particularly where there are space limitations and where power consumption is to be kept to a minimum, for example use as an autofocus camera lens in a mobile phone.

It has been recognised that sensing the lens condition is desirable, to provide a feedback control function. Due to slow charging of the insulators (between the electrodes and the fluids) the relation between the voltage and the exact position of the oil-water meniscus is subject to drift, and a feedback system can compensate for this. If a zoom lens is implemented with multiple variable lenses, it may not be possible to uniquely derive the lens characteristics from optical measurements through the multi-element lens system. It is also therefore desirable to be able to measure the shape of each individual meniscus in such a system.

A conventional electrowetting lens has a bottom electrode and a circumferential wall electrode. It has been proposed that the capacitance across the electrodes can be measured to provide feedback about the shape of the lens. In particular, the shape and the position of the meniscus changes when a voltage is applied, so that the effective size of the annular electrode changes (the effective size depends on the area of water in contact with the electrode, which changes as the meniscus position changes). A resulting change in capacitance can be measured, and this capacitance has been considered to be a reasonably accurate parameter for measuring the strength of the lens.

The use of measured capacitance to determine the lens position requires the thickness and dielectric constant of the insulating coating to be known. This thickness may be subject to variations form batch to batch.

The measurement of capacitance also requires various analogue circuit elements. As the measurement essentially involves analysing charging characteristics, it can also be a relatively slow process, and also requires waveforms of specific frequency. There is therefore a need to control and to maintain the desired lens shape, in a cost effective way, and which is independent of contamination of the liquids.

According to the invention, there is provided a controllable optical lens system comprising:
a chamber housing first and second fluids, the interface between the fluids defining a lens surface;
an electrode arrangement for electrically controlling the shape of the lens surface, the electrode arrangement comprising first and second electrodes; and
a power source for supplying current to the electrode arrangement;
means for monitoring the current supplied by the power source over time and deriving the charge supplied;
means for monitoring the voltage on one of the electrodes of the electrode arrangement; and
means for deriving from a desired lens power a value for controlling the total charge to be supplied to the electrode arrangement.

In the system of the invention, the control of the lens power is achieved by controlling the total charge supplied to the driving electrodes. In the same way that the capacitance of the lens is a function of the meniscus position, control of the lens based on the charge supplied to the lens provides a control scheme which drives the meniscus to a desired position. This means the drive scheme is independent of some of the lens characteristics, but is more easily implemented than a feedback control system using capacitive sensing.

The means for deriving a value is preferably for deriving a ratio of the charge supplied to the voltage. The drive scheme is thus effectively driving the lens to a desired capacitance, but without requiring capacitance measurement, and also as an initial drive scheme rather than a corrective feedback scheme.

The power source is preferably also for maintaining a constant voltage, and is controlled to maintain the voltage on the one of the electrodes after the derived ratio between the charge supplied and the voltage has been reached.

Once the desired lens power has been reached, the lens is driven to a constant voltage to maintain that lens power, and current will be supplied to compensate for leakage currents.

The means for deriving may comprise a look-up table, and the processing power required for implementing the drive scheme can thus be kept to a minimum. The look-up table can receive as input an effective electrode height, which depends on the lens power, and provide as output the ratio of the charge supplied to the voltage.

The electrode arrangement may comprise a drive electrode arrangement comprising a base electrode and a side wall electrode. The lens design can be conventional, and the first fluid may comprise a water based liquid and the second fluid may comprise an oil based liquid.

The invention also provides a method of driving a controllable optical lens, the lens comprising a chamber housing first and second fluid, the interface between the fluids defining a lens surface and an electrode arrangement for electrically controlling the shape of the lens surface, the electrode arrangement comprising first and second electrodes, wherein the method comprises:

selecting a desired lens power;

deriving from the desired lens power a value for controlling the total charge to be supplied to the electrode arrangement;

supplying current to the electrode arrangement;

monitoring the current supplied over time and deriving the charge supplied, and monitoring the voltage on one of the electrodes of the electrode arrangement; and

supplying current until the total charge supplied to the electrode arrangement reaches the derived value.

In this method, the total charge supplied is used as a control parameter for driving the lens, with the advantages outlined above. Preferably, the value for controlling the charge supplied comprises a ratio of the charge supplied to the voltage.

The method preferably further comprises maintaining a constant voltage on the one of the electrodes of the electrode arrangement after the derived ratio between the charge supplied and the voltage has been reached.

Examples of the invention will now be described in detail with reference to the accompanying drawings, in which:

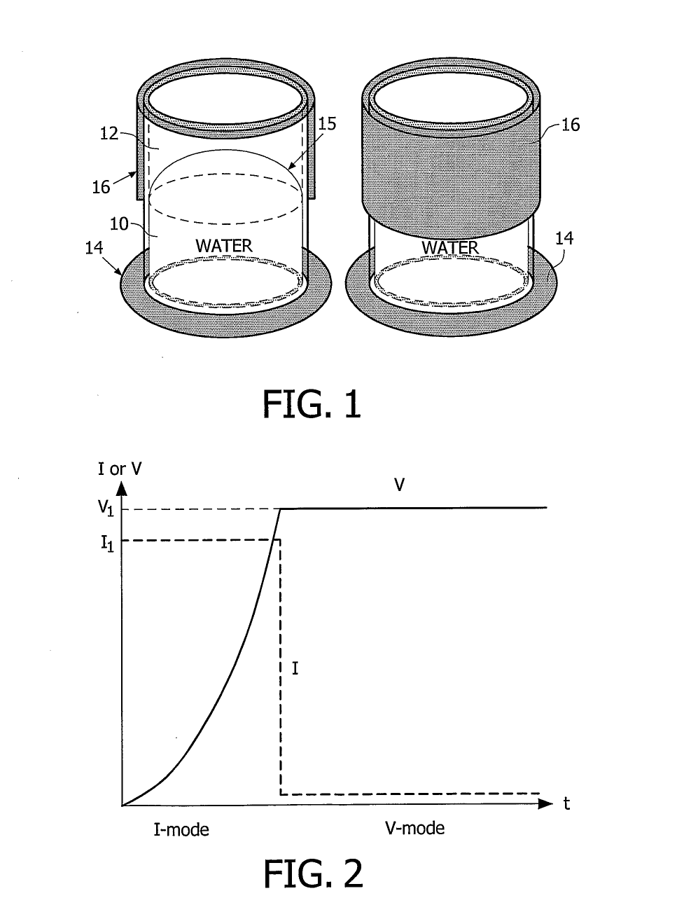

FIG. 1 shows a known design of electrowetting lens;

FIG. 2 is used to explain graphically the drive scheme of the invention;

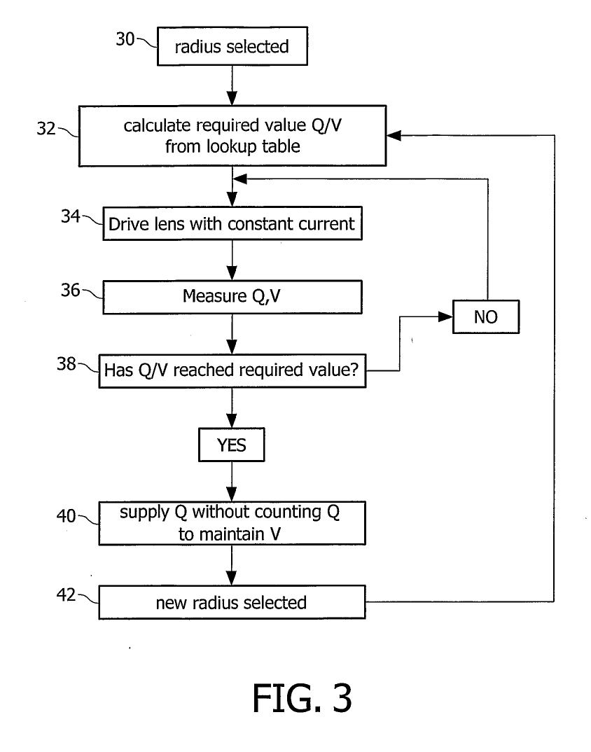

FIG. 3 is shows the drive scheme of the invention in a flow chart;

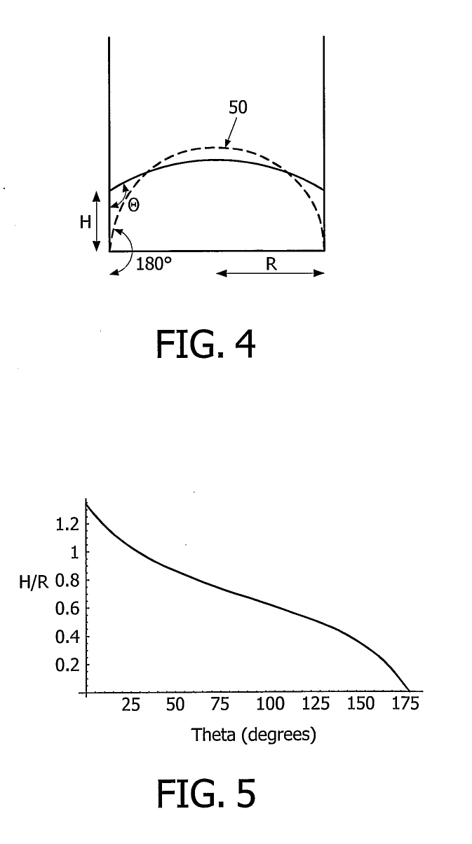

FIG. 4 shows values used in the drive scheme of the invention;

FIG. 5 shows a function for converting between contact angle and electrode height; and

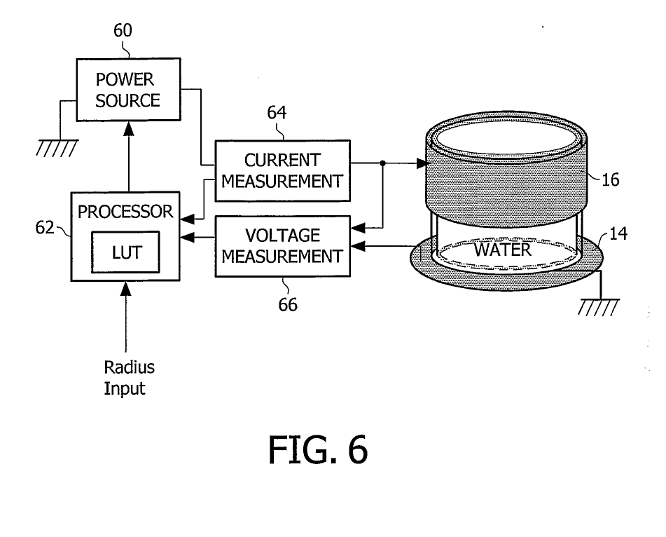

FIG. 6 shows a control circuit for a lens of the invention.

FIG. 1 schematically shows a known electrowetting lens design. The left part of FIG. 1 shows the interior of the lens. The lens comprises a chamber which houses a polar and/or conductive liquid such as a salted water based component 10 (referred to below simply as the water) and a nonconductive liquid such as an oil based component 12 (referred to below simply as the oil). A bottom electrode 14 and a circumferential side electrode 16 control the power of the lens. The side electrode is separated from the liquid by an insulator which forms the side wall of the chamber, and this insulator acts as a capacitor dielectric layer during electrical operation of the lens. This operation will be well known to those skilled in the art, and reference is made to WO 03/069380.

The optical power of an electrowetting lens is determined by the radius of the meniscus formed at the interface of the two liquids. The radius can be derived from the contact angle θ (shown in FIG. 4) of the meniscus at the wall. For the case than the contact angle is less than 180 degrees in the off state, this contact angle is governed by the relation:

$${γ}_{ci} cos θ = {γ}_{wc} - {γ}_{wi} + \frac{1}{2} \frac{{ɛ}_{0} {ɛ}_{r}}{d} {V}^{2} , \qquad ( 1 )$$

where θ is the angle the meniscus makes with the wall, V the voltage applied, γ_{ci} is the water/oil surface tension, γ_{wc} is the wall/water surface tension and γ_{wi} is the wall/oil surface tension, εᵣ the permeability of the insulating layer (the chamber wall) and d its thickness. As a result, the radius of the meniscus is directly related to the voltage applied, and the lens is thus a voltage controlled device.

However, the radius also depends on various other parameters such as the surface tension values, which are not necessarily constant over time or temperature. Contamination of the liquids in time, for example due to dissolution of substances from the housing, may alter these values, which will then alter the relation between V and the radius of the meniscus. Furthermore, charging of the insulating layer in time may occur, which changes the term V in Equation (1) into a term (V-V₀). This effect also affects the relation between meniscus radius and voltage.

The values εᵣ and d are expected to remain significantly constant in time. Therefore, a measurement of the meniscus dependent on these parameters, and independent of the voltage, is expected to be more stable in time.

It has been recognised that measurement of capacitance can be used to provide a feedback function. As the volume of both liquids remains the same and as the interface is spherical, the position of the meniscus at the wall and the radius are directly related. By measuring the position of this interception, the power of the electrowetting lens is known. The relation with the position of the meniscus and the capacitance C of the electrowetting lens is given by:

$$C = \frac{{ɛ}_{0} {ɛ}_{r}}{d} A \qquad ( 2 )$$

where A is the area of the electrode with the insulator layer of thickness d and permeability εᵣ covered by the conducting liquid (the water). Essentially, the size of one of the capacitor electrodes is dependent on the contact height of the water, and the size of the capacitor electrode determines the capacitance.

A drawback of detecting the curvature of the meniscus using capacitance measurement is that it requires additional components to measure the capacitance of the lens separately, introducing extra costs.

The approach of the invention is to measure the total charge supplied into the electrowetting lens, rather than measuring capacitance. This charge is simply the integral over time of the current supplied to the electrowetting lens.

The approach of the invention will first be described, and the hardware to implement the method will then be explained.

FIG. 2 shows the current and voltage profiles for driving the electrodes using the method of the invention. Initially, the lens is charged using a constant current 11 (the “I mode”). When the total charge flow reaches the required level, the lens is driven at a constant voltage V₁ (the “V mode”). In this V-mode, leakage currents are compensated to keep the lens stable in time.

In the V-mode, the supplied charge is no longer measured because in this stage it is used to compensate the leakage currents. From the charge supplied in the I-mode and the resulting voltage V, the following relation is obtained:

$$\frac{Q}{V} = \frac{{ɛ}_{0} {ɛ}_{r}}{d} A \qquad ( 3 )$$

Thus, by measuring the charge flow, and monitoring the voltage drive level, the value of area A is directly known without having to measure the capacitance separately. The radius of the meniscus is directly related to A, as explained above. This relation can for example be programmed in a look up table.

An advantage of using the current directly as the feedback measurement parameter is that it requires no additional components to those already present. Furthermore, this current can be programmed easily so that the total charge supplied to the electrowetting lens is precisely known. The addressing speed can also be increased compared to the methods based on capacitance measurements, which are conventionally carried out after driving the lens to a desired voltage.

The charging current must be chosen such that it is significantly larger than the leakage current, such that leakage currents effects are negligible while charging the lens system.

FIG. 3 shows the drive method in the form of a flow diagram.

In step 30, the desired meniscus radius (i.e. lens power) is selected. This is converted in step 32 to a desired value of Q/V, which equates to a desired capacitance value once the lens has been charged.

In step 34, the constant current is supplied to the side electrodes to charge the lens. While this charging takes place, the total charge is monitored as well as the voltage reached, in step 36.

In step 38 the value of Q/V is monitored, and when the desired level is reached, the control switches to the “V-mode” in step 40.

A constant voltage is then maintained until a new lens power is needed in step 42 and a new value of Q/V calculated, and the drive process is then restarted.

This scheme can be used to change the meniscus radius several times. In order to prevent that the settings acquire a significant offset, after several meniscus switching operations, the electrowetting lens is preferably completely discharged.

A mathematical analysis to derive the Q/V value from the lens power can be carried out with reference to the parameters of the electrowetting lens shown in FIG. 4. The lens may be designed such that in rest, the contact angle is 180 degrees (as shown in dotted lines 50). The meniscus the touches the corner of the cell, hence height H=0 when no charge is supplied to the electrowetting lens. This is not essential, and the geometric analysis still applies when there is non-zero height H with no applied voltage.

The height H as a function of the contact angle is given by

$$H = \frac{2 R}{3 cos θ ( 1 + sin θ )} + \frac{R}{3} ( 2 - tan θ ) \qquad ( 4 )$$

R is the chamber radius, and θ is the contact angle. To select the desired lens power, a required meniscus radius is selected, and this has a corresponding contact angle θ. From equation (4) the required value for H is then found. FIG. 5 is a plot of equation 4. Values representing the graph of FIG. 5 can be stored in the lookup table referred to in step 32 of FIG. 3.

When the required value for H is known, the required value for Q/V is fixed by the relation:

$$\frac{Q}{V} = \frac{{ɛ}_{0} {ɛ}_{r}}{d} 2 π RH \qquad ( 5 )$$

Current is then supplied to the electrowetting lens with the voltage monitored and the charge (integration of the current) is also measured. As soon as equation (5) is fulfilled the system is switched to V-mode and the current is no longer integrated.

For a different radius the above steps are repeated. In this method of addressing the electrowetting lens, the properties of the liquids are not required.

FIG. 6 shows a control circuit for implementing the drive scheme described above.

A power source 60 acts as a current source, and is controlled by a processor 62. The current supplied is measured by current measurement unit 64 and the voltage across the electrodes 14, 16 is measured by voltage measurement unit 66. The units 64, 66 provide feedback to the processor 62 which controls the power source as described above.

The processor 62 includes the look-up table (LUT) for converting a radius input into a desired value of Q/V.

The specific implementation will be routine to those skilled in the art, and there are of course other specific ways of implementing the invention.

The invention effectively implements a capacitive feedback system, but does this without requiring dedicated capacitance measurement and the feedback is implemented as part of the original drive scheme rather than as a corrective procedure after intially driving the lens.

Various modifications will be apparent to those skilled in the art.

1. A controllable optical lens system, comprising:
a chamber housing first and second fluids (10,12), the interface between the fluids defining a lens surface (15);
an electrode arrangement (14,16) for electrically controlling the shape of the lens surface (15), the electrode arrangement comprising first (14) and second (16) electrodes; and
a power source (60) for supplying current to the electrode arrangement;
means for monitoring the current supplied by the power source over time and deriving the charge supplied;
means (66) for monitoring the voltage on one (16) of the electrodes of the electrode arrangement; and
means (62) for deriving from a desired lens power a value for controlling the total charge to be supplied to the electrode arrangement (14,16).

2. A system as claimed in claim 1, wherein the means for deriving a value is for deriving a ratio of the charge supplied to the voltage.

3. A system as claimed in claim 2, wherein the power source is also for maintaining a constant voltage (V₁), and is controlled to maintain the voltage on the one (16) of the electrodes after the derived ratio between the charge supplied and the voltage has been reached.

4. A system as claimed in claim 1, wherein the means for deriving comprises a look-up table (LUT).

5. A system as claimed in claim 4, wherein the look-up table receives as input an effective electrode height, which depends on the lens power, and provides as output the ratio of the charge supplied to the voltage.

6. A system as claimed in claim 1, wherein the electrode arrangement comprises:
a drive electrode arrangement comprising a base electrode (14) and a side wall electrode (16).

7. A system as claimed in claim 6, wherein the side wall electrode (16) comprises an annular electrode which surrounds the chamber.

8. A system as claimed in claim 1, wherein the first fluid (10) comprises a polar and/or conductive liquid and the second fluid (12) comprises a nonconductive liquid.

9. A method of driving a controllable optical lens, the lens comprising a chamber housing first and second fluids (10,12), the interface between the fluids defining a lens surface (15) and an electrode arrangement for electrically controlling the shape of the lens surface, the electrode arrangement comprising first and second electrodes (14,16), wherein the method comprises:
selecting (30) a desired lens power;
deriving (32) from the desired lens power a value for controlling the total charge to be supplied to the electrode arrangement;
supplying current (34) to the electrode arrangement;
monitoring the current supplied (36) over time and deriving the charge supplied, and monitoring the voltage on one of the electrodes of the electrode arrangement; and
supplying current until the total charge supplied to the electrode arrangement reaches the derived value.

10. A method as claimed in claim 9, wherein deriving a value (32) comprises deriving a ratio of the charge supplied to the voltage.

11. A method as claimed in claim 10, further comprising maintaining a constant voltage (40) on the one of the electrodes of the electrode arrangement after the derived ratio between the charge supplied and the voltage has been reached.

12. A method as claimed in claim 9, wherein the deriving a value indicating the total charge to be supplied comprises accessing a look-up table.

13. A method as claimed in claim 12, wherein an effective electrode height is input into the look-up-table, which depends on the lens power, and the ratio of the charge supplied to the voltage is output from the look-up table.
